(19) United States
(12) Patent Application Publication
(10) Pub. No.: US 2009/0148231 A1
(43) Pub. Date: Jun. 11, 2009

(54) STRUCTURE FOR COMBINING MATERIALS OF FURNITURE

(76) Inventor: CHIEN-KUO CHANG, TAICHUNG CITY (TW)

Correspondence Address: FANNY CHUNG, ROOM 1, 7F, NO. 186, SEC. 2, DONG-SHING RD., TAICHUNG CITY (R.O.C.), 408, TW

(21) Appl. No.: 11/952,102

(22) Filed: Dec. 6, 2007

(51) Int. Cl. F16B 12/00

(52) U.S. Cl. 403/346; 403/24; 403/404

(57) ABSTRACT

A structure for combining materials of a furniture product, comprises a wooden material for being used as a vertical component of the furniture product, in which the wooden material has at least a positioning recess and positioning recess comprises at least one receiving surface; a metal material for being used as a horizontal component of the furniture product, in which the metal material has a sectional shape matching a sectional shape of the positioning recess so as to be partially accommodated in the positioning recess; and at least one fastener, for fastening the metal material settled in the positioning recess to the wooden material; wherein when the metal material is settled in the positioning recess of the wooden material, the receiving surface provides a supporting force to the metal material opposite to a gravity of the metal material.

### BACKGROUND OF THE INVENTION

1. Technical Field

The present invention relates to a structure for combining materials and, more particularly to a structure for combining materials of a furniture product.

2. Description of Related Art

With the developments of economics and people's living level, furniture has become not only daily supplies, but also important ornaments, which play an important role in creating the atmosphere and presenting the users' fashion taste. Hence, in addition to utility, another essential factor of furniture is esthetic appearance. In the attempt to produce furniture of high quality that provides diverse visual effect, metal furniture that gives a concise and futuristic image has been introduced to the market as an alternative to consumers.

However, in view of limited nature resources, mass logs for producing wooden furniture are tending scant. Meantime, furniture entirely made of metal materials is disadvantageous by ponderousness and cold feelings. Therefore, some prior technologies intended to integrate wooden and metal materials so as to provide enhanced flexibility in designs of furniture.

Generally, a furniture product having a particular height is constructed from a plurality of boards that are positioned vertically or horizontally and combined mutually so as to stand still. Please refer to FIGS. 1 and 2 for a conventional structure for combining wooden and metal materials. Therein, a wooden board 91 positioned vertically and a metal board 92 positioned horizontally intersect mutually. The wooden board 91 and the metal board 92 abut to each other with a surface thereof. respectively. Then a plurality of fasteners 93, such as screw bolts or rivets, is implemented to fasten the metal board 92 onto the wooden board 91.

However, such conventional structure is structurally defective. As the wooden board 91 has less mass and less strength than the metal board 92, the gravity of metal board 92 that is merely supported by the fasteners 93 can deform the wooden board 91 at the regions around the fasteners 93. Thus, after long-term use, the combination between wooden board 91 and the metal board 92 may become depraved to lead to an unstable structure. Hence, a need exists for providing a structure for combining wooden and metal materials with enhanced firmness and esthetic effect.

### SUMMARY OF THE INVENTION

The present invention provides a structure for combining materials of a furniture product. The main objective of the present invention is to form positioning recesses on a wooden material, which is relatively easier to be processed than a metal material, for providing a vertical supporting force to the metal material positioned in the positioning recesses so as to strengthen a structural strength of the combined materials.

To achieve this and other objectives of the present invention, the disclosed structure for combining materials of a furniture product comprises:

a wooden material for being used as a vertical component of the furniture product;

a metal material for being used as a horizontal component of the furniture product;

wherein the wooden material comprises at least one positioning recess that has at least one receiving surface so that when the metal material is positioned in the positioning recess, the receiving surface provides a supporting force opposite to a gravity of the metal material; and

at least one fastener for fasten the metal material positioned in the positioning recess to the wooden material.

Thereupon, the present invention possesses the following advantages:
1. The disclosed structure combines the wooden material with the metal material to reduce consumption of wood for furniture industry, and is therefore contributive to forestry protection.
2. The disclosed structure combines the wooden material with the metal material to reduce used amount of metals in the furniture, and is therefore helpful to reducing overall weight of the furniture.
3. The disclosed structure allows a furniture product to be composed of two or more than two materials so as to enhance flexibility of furniture design and provide diverse visual effects.
4. The disclosed structure uses a wooden material that is easy to be processed to provide firm support to a metal material so as to enhance structural strength of the combined materials and reduce manufacturing costs.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing a conventional structure for combining materials;

FIG. 2 is a lateral view of the conventional structure for combining materials;

FIG. 3 is a perspective view of a furniture product implementing a structure for combining materials according to the present invention;

FIG. 4 is a partially enlarged drawing of the furniture product in FIG. 3, showing the structure for combining materials according to the present invention;

FIG. 5 is an exploded view of the structure for combining materials according to the present invention; and

FIG. 6 is a lateral view of the structure for combining materials according to the present invention.

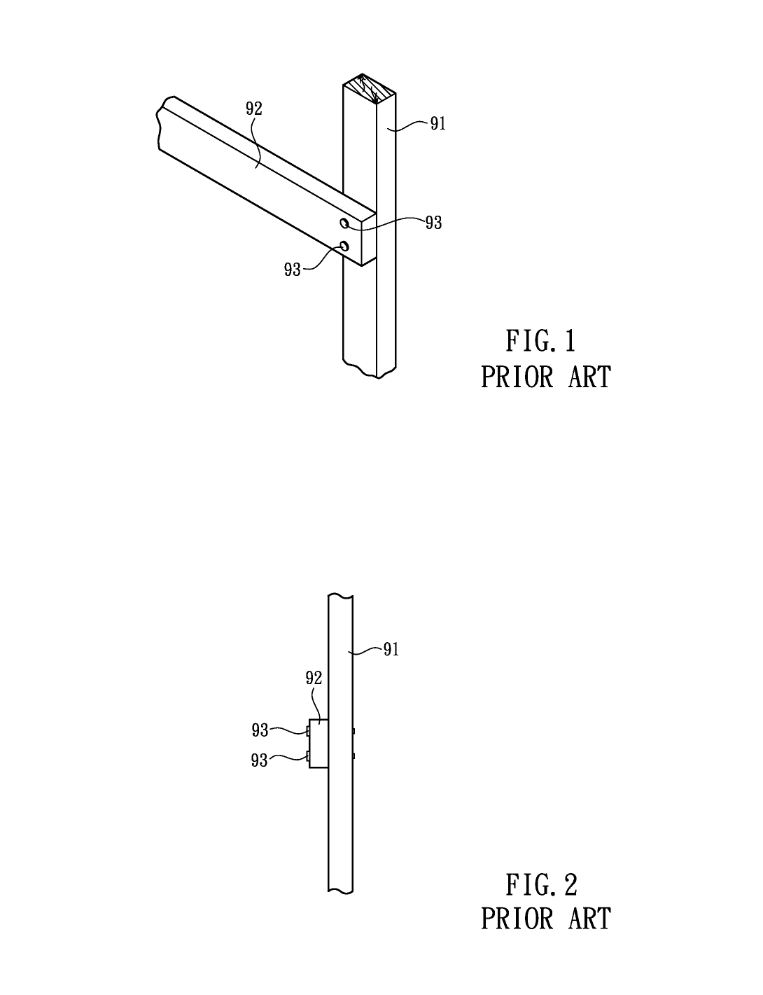

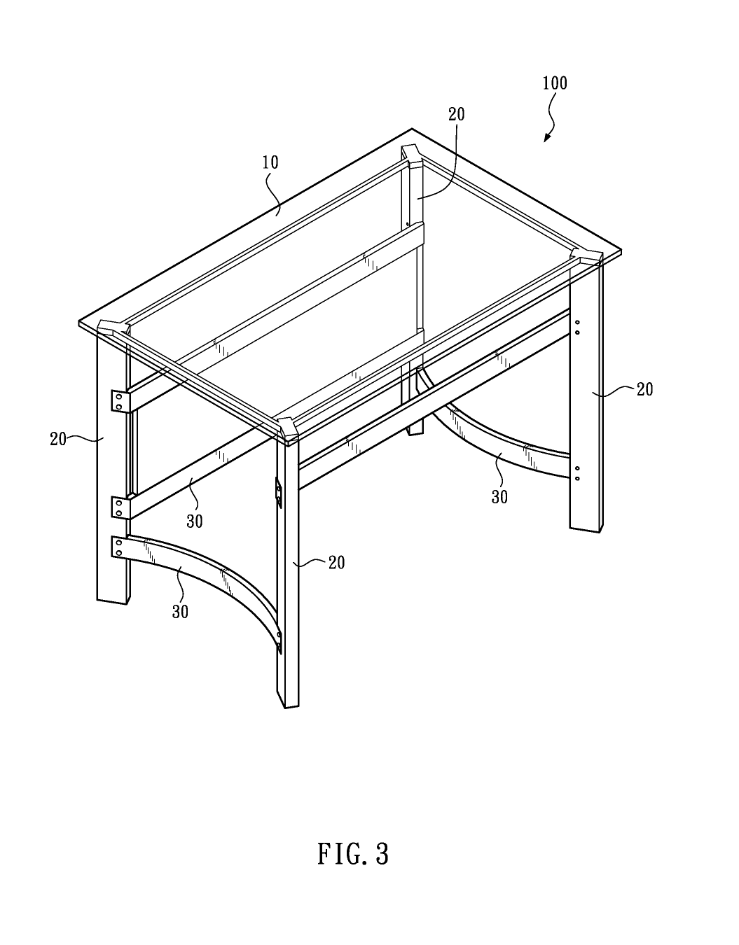

### DETAILED DESCRIPTION OF THE PREFERRED EMBODIMENT

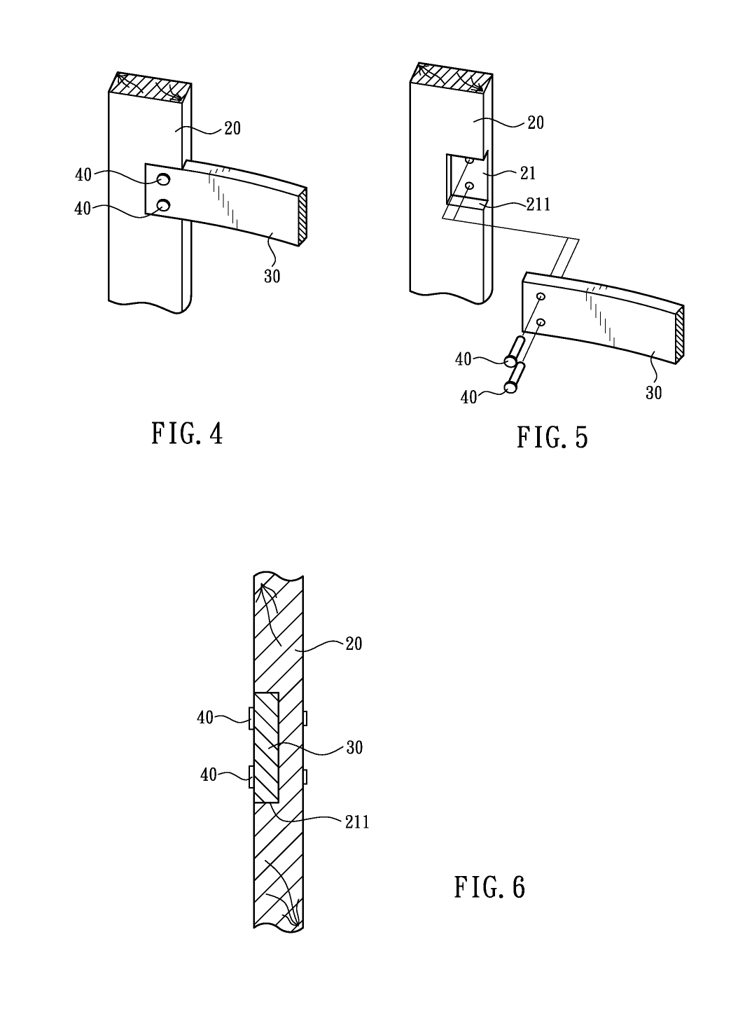

Please refer to FIG. 3 for a table 100 implementing the structure for combining materials of the present invention. The table 100 is primarily constructed from a top 10, a plurality of wooden board 20 provided as vertical components of the table 100 and a plurality of metal board 30 provided as horizontal components of the table 100. In FIGS. 4, 5 and 6, the table 100 is partially enlarged to show the structure for combining materials of the present invention.

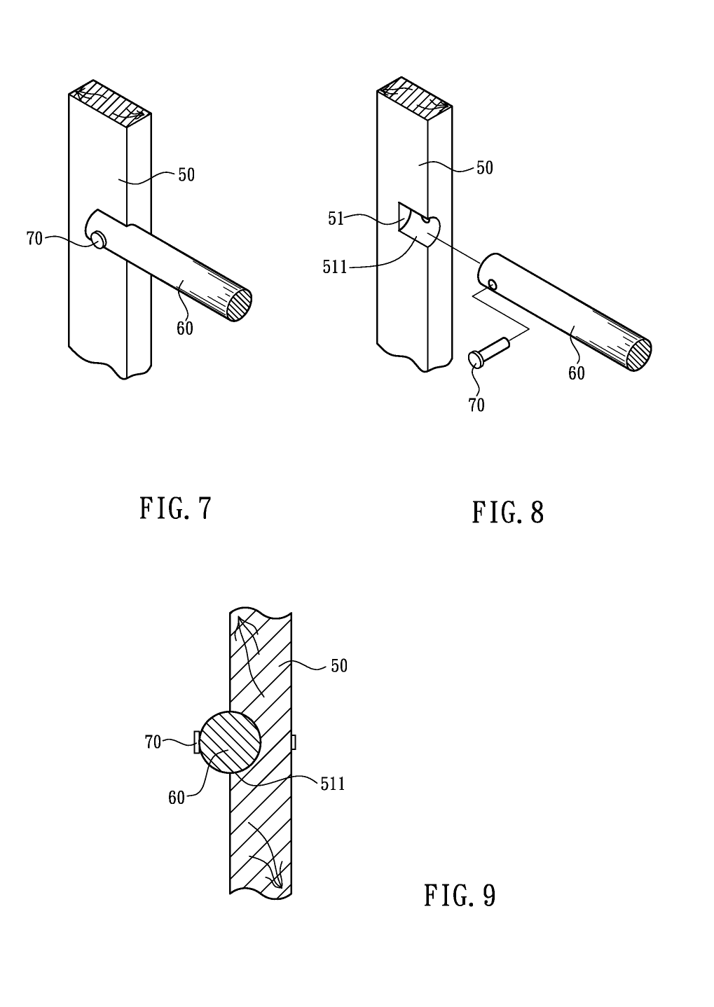

Please refer to FIGS. 4 through 6 for one of the plural wooden boards 20 and one of the plural metal boards 30 that are combined mutually. According to the present embodiment, the wooden board 20 and the metal board 30 are both rectangular boards. Further, the wooden board 20 comprises at least a rectangular positioning recess 21, which has a sectional shape matching the metal board 30 to be assembled to the wooden board 20 so that the metal board 30 can have one section thereof settled in the positioning recess 21. Referring to FIGS. 5 and 6, the positioning recess 21 has at least one receiving surface 211. According to the present embodiment, the receiving surface 211 is a bottom of the rectangular positioning recess 21. so that when the metal board 30 is settled in the positioning recess 21 of the wooden board 20, the receiving surface 211 provides a supporting force to the metal board 30 opposite to a gravity of the metal board 30. Besides, the structure for combining materials of the present invention further comprises at least one fastener 40 for fastening the metal board 30 settled in the positioning recess 21 to the wooden board 20. Therein, the fastener 40 may be a screw set or a rivet set.

In another embodiment of the present invention, the structure for combining materials of the present invention may comprise a wooden board 50 and a metal column 60, as shown in FIGS. 7 to 9. Further, the wooden board 50 comprises at least a semicircular positioning recess 51, which has a sectional shape matching the metal column 60 to be assembled to the wooden board 50 so that the metal column 60 can have one section thereof settled in the positioning recess 51. The positioning recess 51 has at least one receiving surface 511. According to the present embodiment, the receiving surface 511 is a lower edge of the semicircular positioning recess 51 so that when the metal column 60 is settled in the positioning recess 51 of the wooden board 50, the receiving surface 511 provides a supporting force to the metal column 60 opposite to a gravity of the metal column 60. Besides, the structure for combining materials of the present invention further comprises at least one fastener 70 for fastening the metal column 60 settled in the positioning recess 51 to the wooden board 50. Therein, the fastener 70 may be a screw set or a rivet set.

Through the above description it is known that the present invention provides positioning recesses on a wooden material, which is relatively easier to be processed than a metal material, for providing a vertical supporting force to the metal material positioned in the positioning recesses so as to strengthen a structural strength of the combined materials. Therefore, the advantages of easy processing and firm structure can be achieved.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A structure for combining materials of a furniture product, comprising:
a wooden material for being used as a vertical component of the furniture product, in which the wooden material has at least a positioning recess and positioning recess comprises at least one receiving surface;
a metal material for being used as a horizontal component of the furniture product. in which the metal material has a sectional shape matching a sectional shape of the positioning recess so as to be partially accommodated in the positioning recess; and
at least one fastener, for fastening the metal material settled in the positioning recess to the wooden material;
wherein when the metal material is settled in the positioning recess of the wooden material, the receiving surface provides a supporting force to the metal material opposite to a gravity of the metal material.

2. The structure of claim 1, wherein the metal material is aluminum, iron, steel or an alloy thereof.

3. The structure of claim 1, wherein the fastener is a screw set or a rivet set.
